(19) United States
(12) Patent Application Publication
(10) Pub. No.: US 2026/0056786 A1
(43) Pub. Date: Feb. 26, 2026

(54) CONTENT TYPE DELIVERY MANAGEMENT FOR COMPUTATIONAL CAPACITY-CONSTRAINED RESOURCE SYSTEMS

(71) Applicant: Microsoft Technology Licensing, LLC, Redmond, WA (US)

(72) Inventors: Alfonso Andrés LOBOS RUIZ, Bellevue, WA (US); Xiaomeng ZHAO, Beijing (CN); Patrick Richard Lloyd JORDAN, Mercer Island, WA (US); Pranav KHANNA, Hayward, CA (US); Steven Gary ZITTROWER, Orlando, FL (US); Grayson Lloyd WILLIAMS, Atlanta, GA (US); Mohammadreza KHANI, Bellevue, WA (US)

(73) Assignee: Microsoft Technology Licensing, LLC, Redmond, WA (US)

(21) Appl. No.: 18/811,587

(22) Filed: Aug. 21, 2024

(51) Int. Cl. G06F 9/50

(52) U.S. Cl. CPC G06F 9/5027

(57) ABSTRACT

This disclosure describes a content capacity system that provides a framework for solving computational capacity management problems for content providers that provide real-time content distribution. For example, the content capacity system generates and implements resource capacity policies that enable content providers to identify a target distribution location with available resources to provide optimal content types when applied to incoming content requests. Additionally, the content capacity system ensures that resources are efficiently used for the content type with the highest utility and avoids processing infeasible locations and content types, as well as exceeding computational capacities.

### BACKGROUND

The field of digital content distribution is experiencing continuous advancements in both hardware and software. As client devices interface with online services, these platforms facilitate the delivery of dynamic digital content through various content distribution systems. In response, numerous content distribution systems strive to supply this dynamic digital content. However, in seeking rapid delivery, some content distribution systems utilize substantial computational resources. For instance, they employ a range of machine learning models and computational pipelines to generate diverse types and variations of dynamic digital content, which are presented as candidate content. In many instances, some of the generated content cannot feasibly be delivered to the client devices. Overall, many current content distribution systems suffer from significant computational waste and inefficiencies when trying to provide candidate dynamic content. Moreover, these occupied resources prevent content distribution systems from reallocating them to other processes. These issues, among others, are prevalent in current content distribution systems that deliver dynamic digital content.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of a content capacity system for facilitating content delivery based on optimizing the computational capacities of distribution data centers.

FIG. 2 illustrates an example computing environment in which the content capacity system is implemented.

FIGS. 3A-3C illustrate example diagrams of generating content-location pairs between content types and distribution locations.

FIGS. 4A-4B illustrate example diagrams of generating resource capacity policies for the content capacity system.

FIG. 5 illustrates an example diagram of providing a content-location pair in response to a content request using a resource capacity policy.

FIG. 6 illustrates an example series of acts of a computer-implemented method for determining one or more content types to provide in response to a request for content.

FIG. 7 illustrates example components included within a computer system used to implement the content capacity system.

### DETAILED DESCRIPTION

This disclosure describes a content capacity system that provides a framework for solving computational capacity management problems for content providers that provide real-time content distribution. For example, the content capacity system generates and implements resource capacity policies that enable content providers to identify a target distribution location with available resources to provide optimal content types when applied to incoming content requests. Additionally, the content capacity system ensures that resources are efficiently used for the content type with the highest utility and avoids processing infeasible locations and content types, as well as exceeding computational capacities.

In many implementations, the content capacity system provides a framework to optimize computational resource allocation for content distribution systems. Specifically, the content capacity system addresses the technical challenges of managing computational resources for content distribution systems by maximizing service utility without exceeding computational capabilities. In various implementations, the content capacity system utilizes a real-time decision-making process to determine which content type and distribution location to utilize in determining or generating content items (e.g., candidate content items) in response to a content request. By doing so, the content capacity system prevents distribution data centers from expending computational resources on infeasible and/or suboptimal content types.

Implementations of the present disclosure provide benefits and solve problems in the art with systems, computer-readable media, and computer-implemented methods that utilize the content capacity system to provide a content format type and a distribution location for optimally generating content in response to a content request. In particular, the content capacity system utilizes content-location pairs (e.g., content-distribution location pairs) and resource capacity policies to determine which combination of content type and distribution location provides maximum computational efficiency for responding to a content request. Additionally, the content capacity system prevents distribution locations from wasting available computational resources on processing suboptimal or inferable content types.

As described in this disclosure, the content capacity system delivers technical benefits in terms of improved efficiency and flexibility compared to current systems. Moreover, the content capacity system provides several practical applications that address problems related to improving computational capacity management for content providers that offer real-time content distribution.

As mentioned above, the content capacity system improves the efficiency of computing systems that provide real-time content distribution. To illustrate, existing content distribution systems often determines various content items of different content types per distribution location in response to a content request. As an initial problem, these existing systems do not have sufficient computational capacity to generate content items of multiple content types for each content request. In some instances, hundreds of thousands of content requests are received each second. Furthermore, many of the generated content items cannot be feasibly provided to a target client device due to geography, latency, or other constraints. However, many existing systems continue to consume most or all of their available resources generating content that will not be provided to target client devices. This problem further compounds when multiple distribution locations are trying to fulfill the same content request.

In contrast, the content capacity system provides a framework for improving the efficiency and flexibility of content distribution systems. For instance, the content capacity system determines content-location pairs between content type and distribution locations. Furthermore, the content capacity system determines values for each content-location pair based on the relevance and feasibility of the content-location pair. By determining content-location pair values, the content capacity system improves efficiency by preventing distribution locations from generating content that cannot feasibly be provided to a target client device within prescribed time limits.

Additionally, the content capacity system generates and implements a resource capacity policy that indicates expected computational costs for generating content items of each content type at each distribution location. By implementing the resource capacity policy, the content capacity system improves efficiency and flexibility by targeting which content types are most efficiently created at which distribution locations. Then, when combined with the content-location pair values (e.g., generating a utility score for each content-location pair), the content capacity system identifies the content-location pair that is feasible, relevant, and computationally efficient to generate.

Furthermore, the content capacity system improves efficiency by directing resources to the identified content-location pair (e.g., the content-location pair with the highest utility score that is also a positive score). For example, for the identified content-location pair, the content capacity system provides a target content type at a target distribution location. Using this information, a content distribution system can focus on providing content items of the indicated content type from the indicated distribution location. By doing so, available computational resources at the target distribution location are most efficiently used for generating valuable content items. Moreover, the target distribution location is not wasting computational resources on generating suboptimal or unfeasible content items. Additionally, the other distribution locations are also not wasting computational resources on generating suboptimal or unfeasible content items.

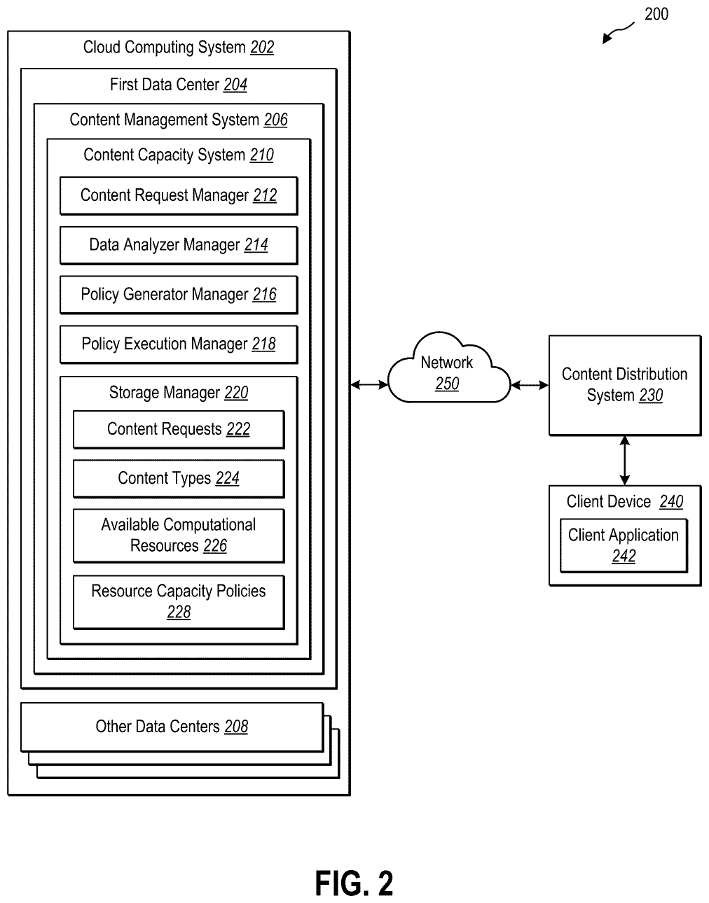

As illustrated in the preceding discussion, this disclosure uses a variety of terms to describe the features and advantages of one or more described implementations. For example, this disclosure describes search engine indexing in the context of a cloud computing system. As an example, the term “cloud computing system” refers to a network of interconnected computing devices that provide various services and applications to computing devices (e.g., server devices and client devices) inside or outside of the cloud computing system. An example of a cloud computing system is described below in connection with FIG. 2.

As an example, the term “content” refers to digital data that is displayable (seen or heard) on a client device. Content can encompass various content items. As another example, the term “content type” refers to a format of content (e.g., a content format type). Different content types can include images, text, videos, or audio clips. In some instances, content also refers to digital ads, and content type refers to different ad types that can be served to a client device.

As an example, the term “location” refers to the physical geography of one or more server devices that receive content requests (e.g., content opportunities). For example, a distribution location includes multiple services at a physical geography that generate multiple content types. As another example, the term “distribution location” refers to one or more server devices at the same physical geography that provide content generation services. In some implementations, a location can also be a distribution location. In some implementations, a data center can function as a location and/or a distribution location. In some implementations, a content capacity system includes multiple locations and/or distribution locations.

As an example, the term “content-location pair” or “content-distribution location pairs” refers to content items associated with a pair of attributes at a given distribution location. In many instances, a content-location pair refers to a content item associated with a content type and distribution location. In some cases, a content-location pair refers to another attribute combination. As an example, the term “content-location pair value” refers to a value determined for a content-location pair based on multiple factors, such as information in the content request and various constraints.

As another example, the term “resource capacity policy” refers to a data structure of computational costs for generating content items for each content type at each distribution location. In various implementations, a resource capacity policy is based on the expected content requests per second anticipated in a time period and/or the distribution of content items of the expected content requests. In various implementations, a resource capacity policy is updated each time period to accurately reflect changing computational resource availability at the distribution locations.

As an example, the term “utility score” refers to a value or metric determined for a content-location pair based on a content request and a resource capacity policy. For example, a utility score indicates whether a content-location pair should be dropped, rerouted, or passed through in response to a content request. Additional information about utility scores is provided below.

As an example, the term “machine learning model” refers to a computer model or computer representation that can be trained (e.g., optimized) based on inputs to approximate unknown functions. For instance, a machine learning model can include (but is not limited to) an autoencoder model, an embedding model, a classification model, a neural network (e.g., convolutional neural networks (CNNs), residual learning neural networks, recurrent neural networks (RNNs), generative neural networks, generative adversarial neural networks (GANs), and single-shot detection (SSD) networks), a decision tree (e.g., a gradient-boosted decision tree), a linear regression model, a logistic regression model, or a combination of these models.

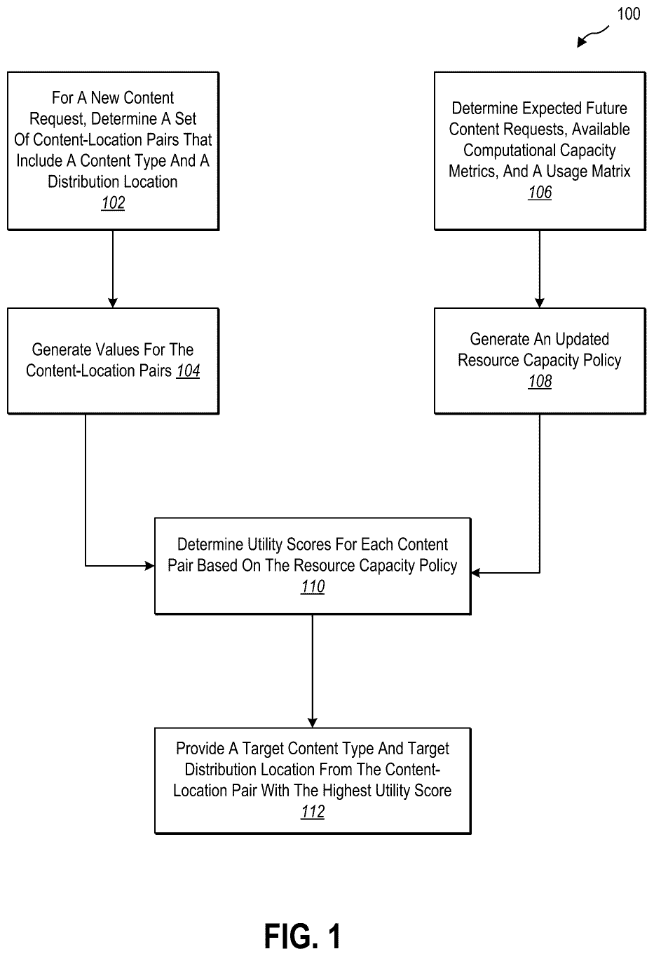

Implementation examples and details of the content capacity system will be discussed in connection with the accompanying figures, which will be described next. For example, FIG. 1 illustrates an example overview of a content capacity system for facilitating content delivery based on optimizing the computational capacities of distribution data centers according to some implementations. While FIG. 1 provides a high-level overview of the invention, additional details are provided in subsequent figures.

FIG. 1 illustrates a series of acts 100 performed by or under the direction of the content capacity system. As shown, the series of acts 100 briefly illustrates an example of how the content capacity system provides a framework for optimizing computational resources at a target distribution location to generate a target content type in response to a content request. Furthermore, by determining a target content type and distribution location, the content capacity system prevents the target distribution location from wastefully generating other content types as well as other distribution locations from generating any content types in response to the content request.

To elaborate, the series of acts 100 includes act 102 of determining a set of content-location pairs that include a content type and a distribution location for a new content request. As mentioned above, the content capacity system receives content requests to provide content items to client devices. In some instances, the content capacity system fulfills content requests by providing one or more candidate content items to an intermediate system, which determines which content item to provide to a target client device.

Accordingly, when a new content request is received, the content capacity system needs to determine how to optimally respond to the request. As an initial step, the content capacity system determines content-location pairs that couple a content type and distribution location. For example, for each distribution location, the content capacity system identifies the content types that can be generated, from which the content capacity system creates content-location pairs.

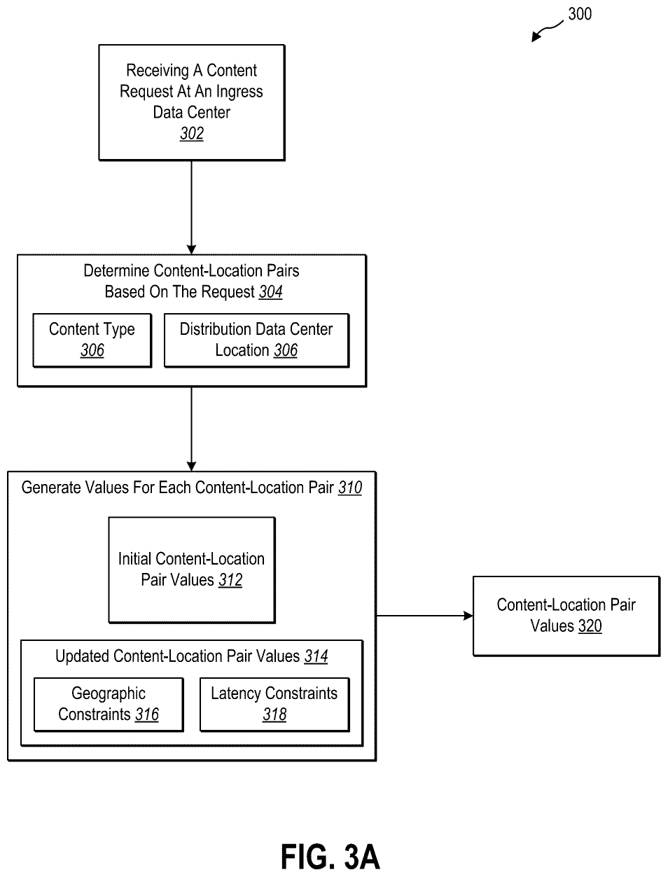

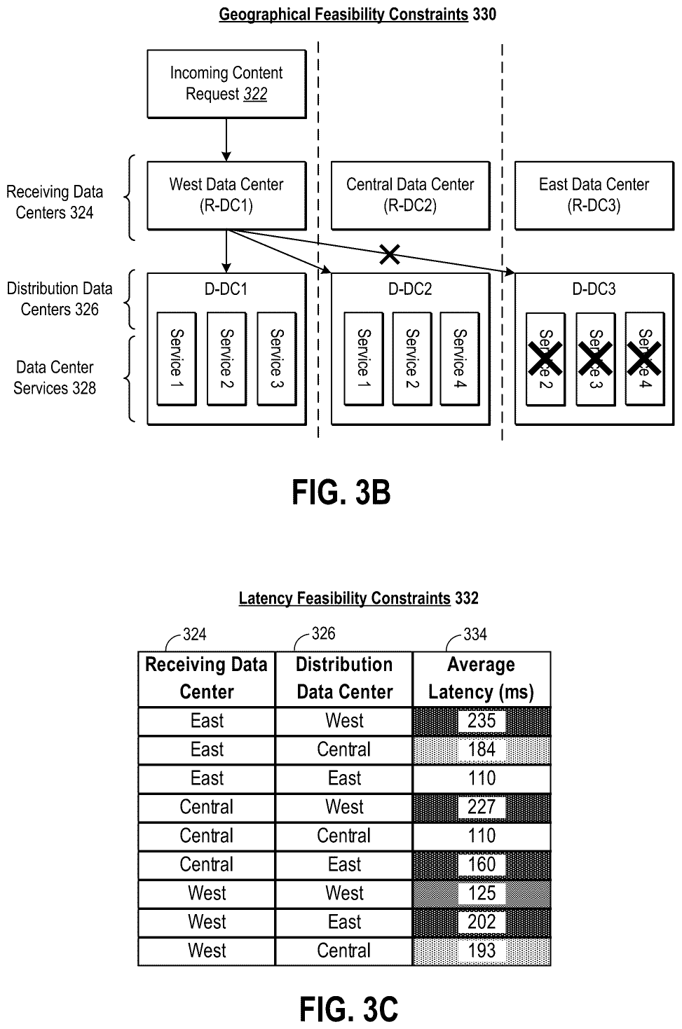

Act 104 includes the content capacity system generating values for the content-location pairs. In various implementations, the content capacity system determines content-location pair values for each content-location pair based on various factors, including information provided in the content request. In some implementations, the content capacity system further refines content-location pair values based on physical and logical feasibility constraints. Additional details about generating content-location pairs and determining content-location pair values are provided below in connection with FIGS. 3A-3C.

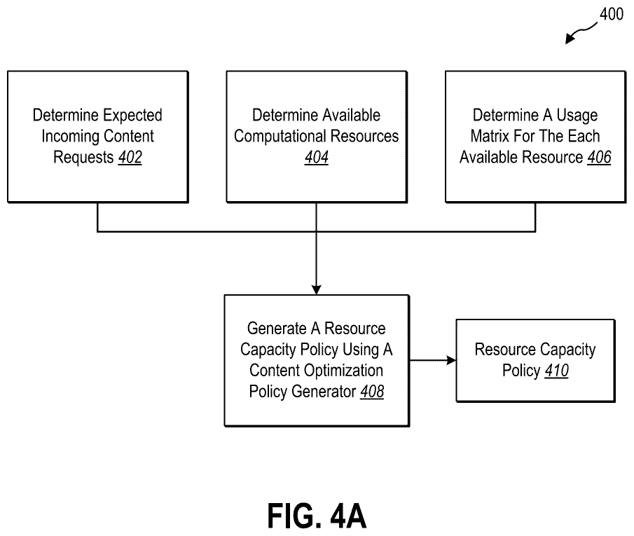

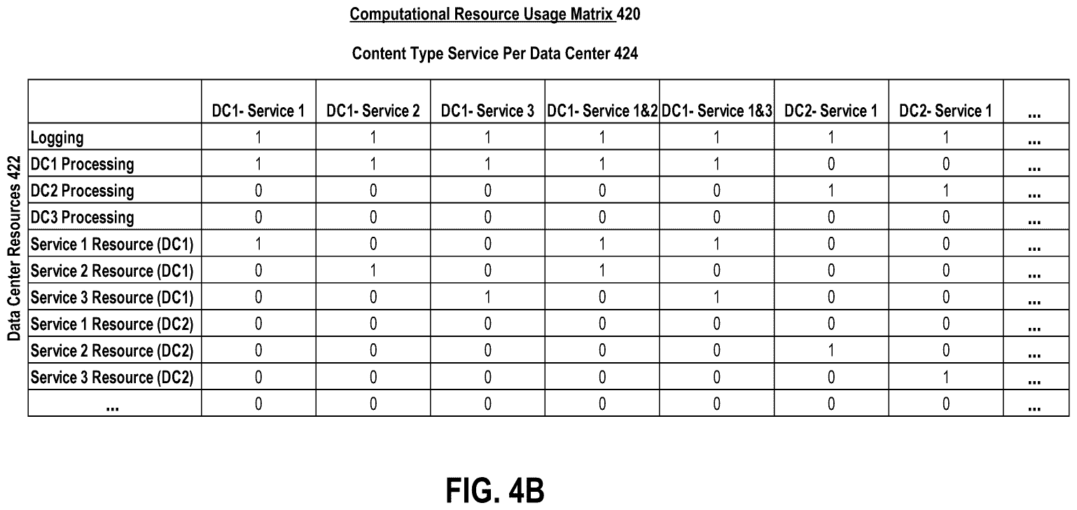

In addition to determining content-location pair values for content requests, the content capacity system can also generate and regularly update the current computational capabilities, which may be used to determine how to efficiently respond to content requests. To illustrate, act 106 includes the content capacity system determining expected future content requests, available computational capacity metrics, and a usage matrix. The content capacity system uses these and other metrics to generate an updated resource capacity policy, as shown in act 108. As noted above, a resource capacity policy can indicate real-time computational costs for generating content items of each content type at each distribution location. Additional details about generating resource capacity policies are provided below in connection with FIGS. 4A-4B.

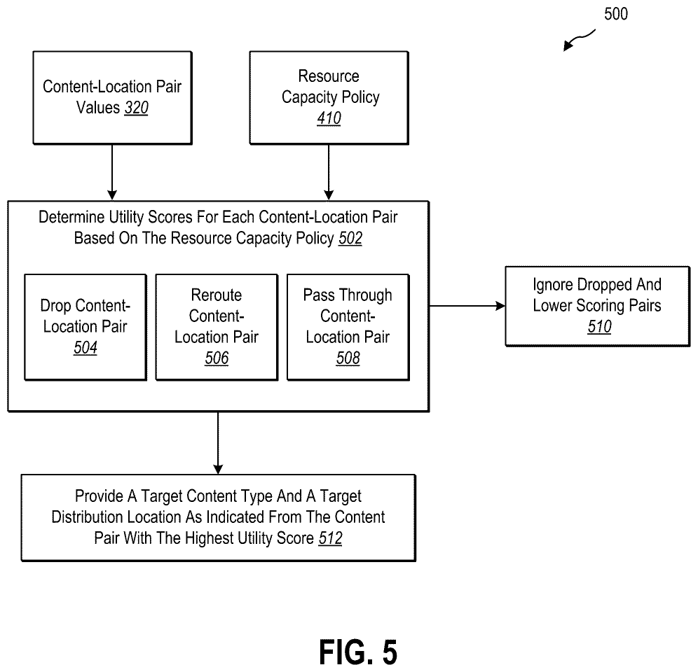

Act 110 includes the content capacity system determining utility scores for each content-location pair based on the resource capacity policy. In various implementations, the content capacity system determines a correspondence between content-location pairs for a content request and currently available computational resources and costs for generating content to respond to the content request. In one or more implementations, the content capacity system utilizes a real-time executor component or model to quickly determine how to process a content-location pair. In various implementations, the content capacity system determines a utility score for each content-location pair. Additional details about determining utility scores for content-location pairs associated with a content request are provided in connection with FIG. 5 below.

Act 112 includes the content capacity system providing a target content type and target distribution locations from the content-location pair with the highest utility score. Upon determining utility scores for each content-location pair, the content capacity system can select the content-location pair with the highest utility score (that is also positive). This selected content-location pair indicates the optimal content type and distribution location pair. In other words, from the selected content-location pair, the content capacity system identifies a target distribution location to use for generating one or more content items of a target content type. By selecting a target content type and distribution location, the content capacity system prevents suboptimal content types and/or distribution locations from being generated and wasting computational resources. Additional details about providing target content types and distribution locations are provided in connection with FIG. 5 below.

With a general overview in place, additional details are provided regarding the components, features, and elements of the content capacity system. To illustrate, FIG. 2 shows an example computing environment where the content capacity system is implemented according to some implementations. In particular, FIG. 2 illustrates an example of a computing environment 200 with various computing devices, including a cloud computing system 202 associated with a content capacity system 210, a content distribution system 230, and a client device 240, connected via a network 250. While FIG. 2 shows example arrangements and configurations of the computing environment 200, the cloud computing system 202, the content capacity system 210, and associated components, other arrangements and configurations are possible.

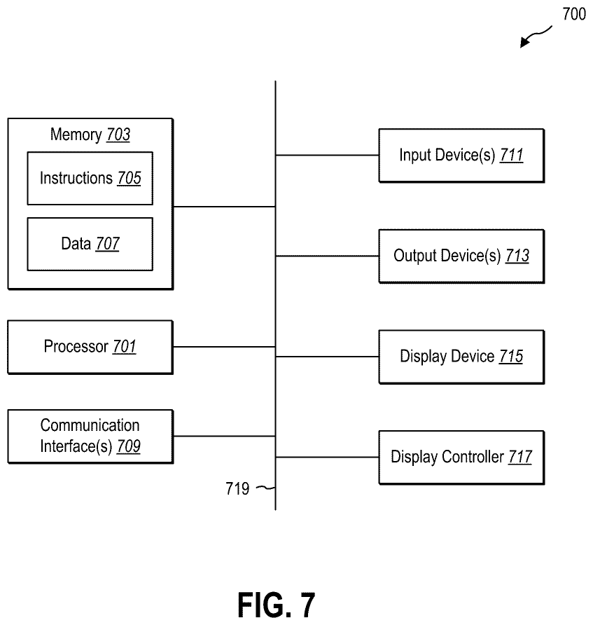

Many of these components shown may be implemented on one or more computing devices, such as on one or more server devices (e.g., a server cluster). In various implementations, some of these components (e.g., the cloud computing system 202 or the client device 240) represent multiple component instances or component versions. In some implementations, one or more components are implemented on the same device. Further details regarding computing devices are provided below in connection with FIG. 7, which also includes additional details regarding networks, such as the network 250 shown.

Before describing the components of the cloud computing system 202, including the content capacity system 210, other components of the computing environment 200 are briefly discussed first to provide better context when describing the content capacity system 210. For instance, the content distribution system 230 manages the distribution of content to the client device 240. For example, the content distribution system 230 identifies when a content opportunity is available on the client device 240 and, in response, provides a content request to the content capacity system 210. In some instances, the content distribution system 230 represents multiple devices and/or systems. In some instances, the content distribution system 230 includes an ad auction system that receives bids for placing ads on online locations accessed by the client device 240.

As shown, the computing environment 200 includes the client device 240 with a client application 242. In some implementations, the client device 240 is associated with a user (e.g., a user client device). In various instances, the client application 242 is a web browser, mobile application, or another type of computer program that provides data and/or services to users. In some instances, the client application 242 on the client device 240 accesses online locations that display dynamic content items associated with the content capacity system 210 to a user.

Returning to the cloud computing system 202, as shown, the cloud computing system 202 includes a first data center 204 and other data centers 208. As mentioned earlier, the data centers within the cloud computing system 202 may represent a receiving, incoming, or ingress location and/or a sending, distributing, or egress location. Additionally, while the first data center 204 is shown with components, each of the data centers may have similar components.

As shown, the first data center 204 includes a content management system 206 and a content capacity system 210. Some or all of the content management system 206 and/or the content capacity system 210 may be located in the data centers of the cloud computing system 202. In some instances, each data center in the cloud computing system 202 includes an instance of the content management system 206 and/or the content capacity system 210.

In various implementations, the content management system 206 performs a variety of functions. In some implementations, the content management system 206 facilitates interactions with various components and systems of the cloud computing system 202. For example, the content management system 206 facilitates the content distribution system 230 in providing content requests, determining or generating content items, and providing generated content to client devices. The content management system 206 may also perform additional content management functions.

The content management system 206 includes the content capacity system 210. In some implementations, the content capacity system 210 is located on a separate computing device from the content management system 206 within the cloud computing system 202 (or apart from the cloud computing system 202). In various implementations, the content capacity system 210 operates independently of the content management system 206.

In various implementations, including the illustrated implementation, the content capacity system 210 includes various components and elements implemented in hardware and/or software. For example, the content capacity system 210 includes a content request manager 212, a data analyzer manager 214, a policy generator manager 216, a policy execution manager 218, and a storage manager 220. The storage manager 220 includes content requests 222, content types 224, available computational resources 226, and resource capacity policies 228.

To elaborate, in various implementations, the content request manager 212 receives content requests 222 for providing content to the client device 240 via the content distribution system 230. In various implementations, the content request manager 212 generates content-location pairs based on content types 224 available to be generated at the various data centers. In some implementations, the content request manager 212 also determines content-location pair values for the content-location pairs, which are further described below.

The data analyzer manager 214 identifies processes, analyzes, and/or otherwise manages data and resources associated with the first data center 204 and/or the content capacity system 210. For example, the data analyzer manager 214 monitors the resource capacity policies 228 and determines metrics such as demand prediction (e.g., forecasted number of incoming content opportunities per second and/or a sample of content opportunities to come in the next time period) and capacity prediction (e.g., an estimate of the maximum available computational calls each resource can serve per second in the next time period). In some implementations, the data analyzer manager 214 generates a usage matrix, which can indicate computational calls that would be used when calling different content-location pairs

The policy generator manager 216 generates and updates the resource capacity policies 228. In various implementations, a resource capacity policy solves a linear optimization problem that is generated using demand prediction, capacity prediction, and usage matrix components. The policy execution manager 218 decides whether to drop, reroute, or pass through content opportunities for a content request based on content-location pair values and resource capacity policies 228. Often, the policy generator manager 216 makes real-time evaluations by comparing content-location pair values to the resource capacity policies 228. Additional details regarding policy generation and execution are provided below.

Moving on to the next set of figures, these figures illustrate examples of the content capacity system 210 performing different processes to determine optimal content-location pair combinations that maximize computation efficiency across distribution locations (e.g., data centers) in a cloud computing system. To begin, as mentioned above, FIGS. 3A-3C provide additional detail about generating content-location pairs and determining content-location pair values. In particular, FIGS. 3A-3C illustrate example diagrams of generating content-location pairs between content types and distribution locations according to some implementations.

As shown, FIG. 3A includes a series of acts 300 performed by the content capacity system 210 to generate content-location pair values based on requested content. In addition, some of the acts include corresponding elements or components.

Act 302 includes receiving a content request at an ingress data center. For example, the first data center serves as an ingress data center where the content capacity system 210 receives content requests to provide content items to client devices. A content request may include request information, such as information about the target client device and/or an associated user identifier. In some implementations, the content request includes a response time limit or response threshold (e.g., 100 milliseconds) within which a candidate item must be provided to be displayed on the client device. For instance, the content request is an ad-opportunity request to display an ad on a client device of a target user, and the request includes a timeframe in which a given time frame candidate ads must be provided to an online ad auction.

Act 304 includes the content capacity system 210 determining content-location pairs based on the request. In various implementations, a content-location pair includes a content type 306 paired with a distribution data center location 308. To elaborate, for a given distribution data center location, the content capacity system 210 identifies which content types can be created (e.g., the data center includes the services needed to generate content of an identified content type). Furthermore, the content capacity system 210 creates pairs between the given distribution data center location and each of the content types offered by the data center. In some implementations, a content-location pair may represent an ad type pair that includes an ad type and an egress data center (e.g., distribution data center location).

Similar to generating content-location pairs based on content type in a given distribution data center location, the content capacity system 210 may also generate content-location pairs based on content types available at each additional distribution data center location within the cloud computing system 202. In some implementations, multiple distribution data center locations will provide the same content type. Accordingly, one content-location pair may include Content Type A with Location A while a second pair may include Content Type A with Location B.

In some implementations, a content-location pair includes additional and/or different elements. For example, a content-location pair is a tuple, group, or another pairing with additional elements associated with determining or generating content items in response to content requests. For example, a content-location pair or group includes an ingress data center (where the request was received), an egress data center (e.g., where a content item will be generated), and a content type. In some instances, a content-location pair or group includes timing information (e.g., a response time limit) and/or other information included in the content request.

Upon generating content-location pairs corresponding to some or all of the content types offered at some or all of the distribution data center locations, the content capacity system 210 can generate values for the pairs. To illustrate, act 310 includes generating values for each content-location pair associated with the content request. As shown, the content capacity system 210 generates initial content-location pair values 312, then updates them to generate updated content-location pair values 314.

In various implementations, the content capacity system 210 generates the initial content-location pair values 312 based on correlating the content request to the content values. For example, in some instances, the content capacity system 210 utilizes a content valuation machine learning model trained to estimate the utility or value of providing a content item of the content type to the client device based on characteristics, attributes, and values included in the content request.

In one or more implementations, the content valuation machine learning model determines and/or identifies features of a content request (e.g., a content opportunity) and generates expected values for providing or serving content of a given content type based on the identified features. In various implementations, the content valuation machine learning model provides real-time content-location pair values for each content-location pair in the content-location pair set. In some implementations, the content valuation machine learning model is updated regularly, such as daily, weekly, or monthly. In cases where the content is in an ad, the content valuation machine learning model determines an estimated value of serving the ad in response to the ad request or ad opportunity.

Upon generating the initial content-location pair values 312, the content capacity system 210 updates the values based on the distribution location that will generate and provide content items of a corresponding content type. As shown in FIG. 3A, the content capacity system 210 generates the updated content-location pair values 314 based on geographic constraints 316 and latency constraints 318. In some instances, these constraints provide an indication of the feasibility of providing corresponding content in response to the content request.

To elaborate, in various implementations, the content capacity system 210 updates the initial content-location pair values 312 based on geographic constraints 316. In general, geographic constraints 316 correspond to the feasibility of receiving the content request at a first data center and providing content items of a given content type from a second data center. In some instances, the first data center and the second data center are not adequately connected. Furthermore, not all data centers provide services for all content types, making a content-location pair unfeasible.

To illustrate, FIG. 3B shows a diagram of geographical feasibility constraints 330. In particular, FIG. 3B corresponds to geographical connections between data centers. As shown, FIG. 3B includes receiving data centers 324 and distribution data centers 326. In some instances, the same data center is both the receiving data center and the distribution data center. Each of the distribution data centers 326 also shows various services 328, which may represent content type services. This figure has been simplified for purposes of explanation.

As shown, an incoming content request 322 is received at the first receiving data center (R-DC1). In response, the content capacity system 210 generates content-location pairs that correlate the distribution data centers 326 with their content type services. For example, the content capacity system 210 generates the following content-location pairs between a distribution data center and a service: D-DC1: S1, D-DC1: S2, D-DC1: S3, D-DC2: S1, D-DC2: S2, D-DC2: S4, D-DC3: S3, D-DC3: S3, and D-DC3: S4. Additionally, the content capacity system 210 generates initial content-location pair values for each of the content-location pairs. For example, the content capacity system 210 utilizes a content valuation machine learning model to generate initial content-location pair values that score each pair based on their utility, gain, or correlation to the incoming content request 322.

The content capacity system 210 can then update the content-location pair values based on the geographical feasibility constraints 330 between the first receiving data center (e.g., R-DC1) and distribution data centers. For instance, when a data center is both the receiving data center and the distribution data center for a content-location pair, the content capacity system 210 may positively adjust the content-location pair value or leave the value unchanged. For example, for the content-location pairs of D-DC1: S1, D-DC1: S2, and D-DC1: S3, the content capacity system 210 may increase or not change their content-location pair values based on geographic feasibility.

When the receiving data center differs from the distribution data center, the content capacity system 210 may determine whether the data centers are adequately connected. For example, two adjacent data centers may be feasibly connected while two data centers located on opposite sides of the globe may not be. To illustrate, in FIG. 3A, the first receiving data center (R-DC1) is shown with the arrow as being adequately connected with the second distribution data center (D-DC2). In some instances, if a distribution data center connects with the receiving data center, the content capacity system 210 does not change or modify the value of modified content-location pairs (e.g., D-DC2: S1, D-DC2: S2, D-DC2: S4). In some cases, the content capacity system 210 adjusts or lowers the corresponding content-location pair values based on the proximity of the connected data centers.

In addition, the first receiving data center (R-DC1) is also shown by the crossed-out arrow as not being adequately connected to the third distribution data center (D-DC3). In some instances, the content capacity system 210 may lower or reduce the values of the corresponding content-location pairs. For example, the content capacity system 210 changes the content-location pair values of D-DC3: S3, D-DC3: S3, and D-DC3: S4 to zero or near zero to indicate a geographic constraint. In some instances, the content capacity system 210 drops or excludes content-location pairs from distribution data centers that are not feasibly connected to the receiving data center. Regardless of the specific approach taken, the content capacity system 210 indicates that content-location pairs with services from an unconnected distribution data center (e.g., D-DC3) are not available to fulfill the incoming content request 322 (as indicated by the crossed-out services in FIG. 3B).

While FIG. 3B shows a simplified diagram, in various implementations, the content capacity system 210 maintains and utilizes a feasibility matrix that indicates feasible connections between data centers. For example, the feasibility matrix indicates which pairs of incoming (ingress) data centers and serving (egress) data centers are feasible. In some implementations, the feasibility is based on content type. For instance, a second distribution data center is feasibly connected to a first receiving data center for a first content type, but the second distribution data center is not feasibly connected to the first receiving data center for a second content type.

In various implementations, the content capacity system 210 adjusts the content-location pair values based on latency constraints 318. Similar to geographic constraints 316, latency constraints 318 may render one or more services offered by distribution data centers unfeasible. Specifically, if the latency for generating and providing content items of a given content type exceeds a response time limit or threshold, then it would be less feasible or infeasible for the distribution data centers to generate content items of that content type

To illustrate, FIG. 3C shows an example table of latency feasibility constraints 332. The table includes columns for the receiving data centers 324, the distribution data centers 326, and average latency times 334 (in milliseconds). The table may include additional columns, such as different latency distribution percentiles between data center pairs. In some implementations, latency times are further divided or categorized by the content type being provided.

In various implementations, the content capacity system 210 generates the table using historical processing times between data center pairs. In addition, the chart may be updated frequently to reflect current latency information.

In various implementations, the content capacity system 210 adjusts the content-location pair values based on latency times. For example, the content capacity system 210 utilizes a latency penalty model or function to determine the probability that content items from the distribution data centers could be provided before or within a certain number of milliseconds. In some implementations, the content capacity system 210 determines the probability of responding to the content request before the maximum time for each pair of ingress-egress data centers for corresponding content-location pairs (e.g., using different content types). Based on one or more of these probabilities, the content capacity system 210 modifies the content type value for each content-location pair (e.g., lowering the value based on the penalty).

In some implementations, if the latency time for a content-location pair exceeds a response time threshold (e.g., a maximum response time), the content capacity system 210 modifies the content-location pair value to or near zero. In particular, when a content-location pair has a distribution data center that when paired with the receiving data center, has a latency time that exceeds the response time threshold indicated in the content request for responding to the request, the content capacity system 210 modifies the value for the content-location pair to zero.

In one or more implementations, the content capacity system 210 applies different penalties or value adjustments based on the latency time. For example, the content capacity system 210 compares the latency time for a content-location pair to a set of ranges, where each range is associated with different value adjustments. In these implementations, larger latency times result in larger value or score reductions.

In some implementations, the content capacity system 210 adjusts content-location pairs based on additional or different constraints. By adjusting the content-location pair values based on the feasibility of a content-location pair with the receiving data center, the content capacity system 210 can improve system and computing efficiency by promoting content-location pairs that are likely to be successful and penalizing combinations that may fail to respond within the allowed time.

Returning to FIG. 3A and the series of acts, act 310 results in the content capacity system 210 generating content-location pair values 320 upon updating the initial content-location pair values based on feasibility constraints. As mentioned earlier, the content capacity system 210 may perform the series of acts 300 in a short period of time to allow ample time for selecting a content-location pair, determining or selecting content items as a target distribution data center, and providing the content items in response to the content request within the response threshold and/or a maximum response time limit.

The content capacity system 210 can compare the values of the content-location pair to a resource capacity policy to generate utility scores for each content-location pair. As mentioned above, FIGS. 4A-4B provide additional detail on generating resource capacity policies. In particular, FIGS. 4A-4B illustrate example diagrams of generating resource capacity policies for the content capacity system according to some implementations.

As shown, FIG. 4A includes a series of acts 400 performed by the content capacity system 210 to generate resource capacity policies. In particular, the content capacity system 210 obtains computational demand parameters, computational capacity parameters, and computation usage metrics as part of generating a resource capacity policy. In addition, the content capacity system 210 may generate a resource capacity policy based on additional parameters and metrics.

To elaborate, act 402 includes the content capacity system 210 determining expected incoming content requests. In some implementations, the expected incoming content requests correspond to expected computational demand parameters (e.g., a demand prediction). For example, the content capacity system 210 determines or predicts the average expected number of content requests (e.g., ad opportunities) per second over a predetermined time period (e.g., 30 or 60 seconds). In addition, the content capacity system 210 may update the expected incoming content requests for each time period.

In some implementations, the content capacity system 210 also generates a representative sample of the content requests expected in the next time period. For example, in some instances, the content capacity system 210 creates a sample of content requests expected to be received in the next time period based on the receiving data center and possible content-location pair combinations.

Act 404 includes the content capacity system 210 determining available computational resources. For example, the content capacity system 210 determines which content type services are currently available at the distribution data centers within the cloud computing system. In some implementations, the available computational resources correspond to computational capacity parameters (e.g., a capacity prediction).

In one or more implementations, the content capacity system 210 estimates the maximum number of computational calls that each resource (e.g., service) can handle or serve per second in the next time period at each distribution data center. For example, the content capacity system 210 predicts the computational capacity available for the next time period, where capacity is determined for each resource and measured as the maximum number of computational calls per second that each resource can receive. In some implementations, the content capacity system 210 takes into account future capacity-affecting events, such as upcoming maintenance. In various implementations, the content capacity system 210 utilizes the last known computational capacities of the system with regular updates every 30 or 60 seconds, as data centers can continuously change their resource capacities.

Act 406 includes the content capacity system 210 determining a usage matrix for each available resource. In various implementations, a usage matrix is a computational resource service usage calculator that indicates which resources are used (and to what amount or extent) at a distribution data center when generating a content item of a given content type. Indeed, a usage matrix indicates the computational costs (in terms of calls and resources) of executing a content type service at a given data center within the cloud computing system.

To briefly illustrate, FIG. 4B shows an example of a computational resource usage matrix 420. As shown, the matrix includes rows of data center resources 422 and columns of content type services per data center 424. For simplicity, only a partial portion of the usage matrix is shown.

As shown, for each content type service at a given data center, the matrix indicates each resource needed to generate a content item of the given content type (e.g., content format type) at the given data center. In some instances, a data center includes additional resources to perform a service. In various instances, the content capacity system 210 updates the matrix table hourly, daily, weekly, or at another interval.

For example, for the first service at the first data center (the second column), to generate a corresponding content item, the required resources include using a logging resource, a processing resource at Data Center 1, and a Service 1 Resource at Data Center 1. Similarly, for the sixth column (DC1—Services 1&3), the required resources include using a logging resource, a processing resource at Data Center 1, and the Service 1 Resource and a Service 3 Resource at Data Center 1.

Additionally, while each resource is shown as a single call or computational cost, in some implementations, a service requires more or less computational costs. For example, a resource may have a computational cost of 1.2 if it takes on average 20% more computational resources than a more typical computational call. Likewise, a resource may have a value less than 1 if it takes fewer resources than an average call.

Upon obtaining the expected incoming requests (e.g., computational demand parameters), available computational resources (e.g., computational capacity parameters), and usage matrix (e.g., computation usage metrics), the content capacity system 210 can generate a resource capacity policy. To illustrate, returning to FIG. 4A, act 408 includes the content capacity system 210 generating a resource capacity policy 410 using a content optimization policy model.

As mentioned above, the content capacity system 210 utilizes a resource capacity policy to maximize the efficiency and utility in resource usage of the distribution data centers for each time period without exceeding computational resource constraints. For example, the content capacity system 210 generates an optimization problem (e.g., content opportunity allocation problem) based on the computational demand parameters, computational capacity parameters, and the usage matrix, determines a solution, and transforms the solution into the resource capacity policy.

In various implementations, the content capacity system 210 trains the content optimization policy model based on near-real-time inputs, including system samples, resource capacities, latency, information, and content request demand parameters. In some implementations, the content capacity system 210 utilizes fixed inputs, such as a feasibility matrix, usage matrix, and ingress-egress data center data to train the content optimization policy model. In various implementations, the content capacity system 210 trains the content optimization policy model to generate resource cost vectors, expected data center latencies, rerouting penalties, and/or stack combination benefits as part of a resource capacity policy 410.

In various implementations, the content capacity system 210 generates a resource capacity policy 410 by solving a linear optimization problem (e.g., a content opportunity allocation problem) that is generated using the computational demand parameters, computational capacity parameters, and the usage matrix. As a non-limiting example, consider the following mathematical formulation of the optimization problem and determine a corresponding solution.

To elaborate, the content opportunity allocation problem may be defined by the sets, parameters, and variables described below. Additionally, for better understanding, the content opportunity allocation problem is described as an ad opportunity allocation problem; however, the principles and applications can be extended to other types of content opportunity allocation problems.

### Sets:

j ∈J: Set of ad opportunities.
i ∈I: Ingress data centers (a set of data centers in which an ad opportunity can be received).
e ∈E: Egress data centers (a set of data centers in which ad opportunities can be served).
r ∈R: Set of resources in the system.
α ∈A: Set of the different ad format types.
(i, j, α) ∈ F: Set of feasible tuples for where ad opportunities received in Ingress Data Center i can be served by Egress Data Center e using Ad Format Type α.

### Parameters:

i (j) ∈ I: The ingress data center in which the Ad Opportunity j is received.
v (j, i (j), e, α) ∈ [symbol] : Expected value for Ad Opportunity j if it is served in Egress Data Center e and uses the Ad Format Type α.
u (r, e, α) ∈ [symbol] : Usage Matrix: The utilization for Resource r if serving an ad opportunity using Ad Format Type α in Egress Data Center e.
C(r): Total capacity per second for Resource r.

### Variables:

x(j,e, α) ∈ [0,1]: If Ad Opportunity j is served in Egress Data Center e using the Ad Format Type α, then:

$$maximize {\sum }_{j ∈ J} {\sum }_{( i ( j ) , e , a ) ∈ F} v ( j , i ( j ) , e , a ) \cdot x ( j , e , a ) \\ s . t . {\sum }_{j ∈ J} {\sum }_{( i ( j ) , e , a ) ∈ F} u ( r , e , a ) \cdot x ( j , e , a ) \leq C ( r ) for all r ∈ R \\ {\sum }_{( i ( j ) , e , a ) ∈ F} x ( i ( j ) , e , a ) \leq 1 for all j ∈ J$$

In the ad opportunity allocation problem above, the ingress data center in which an ad opportunity is received is fixed. Additionally, for an ad opportunity, the content capacity system 210 can take different valuations depending on the content-location pair, which can include the data center pair (ingress data center, egress data center) and an ad format type chosen. In addition, as discussed above, content-location pair values may be affected by the feasibility of routing, latency, and how suitable each ad type is for the incoming ad opportunity (i.e., incoming content request). To illustrate, Set F shows which combinations of ingress and egress are allowed to serve which ad types. In some instances, the set may be empty. In alternative implementations, the set includes multiple content-location pairs.

As shown in this example, the content capacity system 210 has defined the problem as an optimization problem with linear variables. By solving this problem, the content capacity system 210 is able to identify one ingress-egress data center pair and one ad type (e.g., a binary-like solution) because the way the content capacity system 210 solves the problem naturally leads to a binary solution.

Accordingly, with a linear optimization problem, in various implementations, the content capacity system 210 can solve it using duality. For instance, using duality, the content capacity system 210 changes the original problem that aims to find an allocation for all ad opportunities to one that just finds a positive (dual) variable for each resource in the system. To elaborate, in this example, the vector of dual solutions may be called the dual vector A. In some implementations, A is determined by using linear programming solvers or first-order methods for online allocation problems.

In some implementations, a dual vector/may represent a resource capacity policy by running Algorithm 1, shown below. Once we have found a A dual vector, we can use it to define a real-time policy using Algorithm 1 below.

Algorithm 1: Executor Real-Time Policy From (λ, F, u):

```
$Input : Dual vector λ ∈ {ℜ}_{+}^{\# R} ,$
the feasible set of ingress-egress data center combinations and ad types F, and
the “utilization matrix” u
1. For an incoming ad opportunity with i as its ingress data center, call the valuation
  component and obtain v(i, e, a) for all (i, e, a) ∈ F.
2. For all (e, a) with (i, e, a) ∈ F do:
  a. Calculate π̅(̅e̅,̅ a̅)̅ = v(e, a) − Σ_{r∈R} u(r, e, a) · λ (r)
If π̅(̅e̅,̅ a̅)̅ ≤ 0 for all (e, a) with (i, e, a) ∈ F, do not serve the ad opportunity,
otherwise serve it in (e, a) with (i, e, a) ∈ F with the highest π̅(̅e̅,̅ a̅)̅.
```

In various implementations, the executor policy is parallelizable, the number of operations is O (#R· #E· #A), and it can be made even faster by storing Σ_{r∈R} u(r, e, α)·λ(r) for all feasible (e, α) pairs (reducing the complexity to O(#R)). λ is not only useful for solving the optimizer problem efficiently, but it also has an important computing efficiency interpretation by itself. λ(r) represents how much a content distribution system would need to provide for increasing one unit/second resource r.

Using the above, in one or more implementations, the content capacity system 210 solves the optimizer problem using a representative sample of the ad opportunities coming in the next minute (or a different time frame). In some instances, the content capacity system 210 also solves the optimizer problem using real system quantities for a future time period (e.g., the next minute). Once the dual vector A is obtained, the content capacity system 210 utilizes Algorithm 1 over the ad opportunities to obtain the allocation solutions x[λ] (j, e, α).

Returning to FIG. 4A, act 408 corresponds to generating and training a content optimization policy model to generate a resource capacity policy 410. For instance, the content capacity system 210 employs the above approach to generate the resource capacity policy 410.

Additionally, in various implementations, the content capacity system 210 repeats the series of acts 400 at regular intervals. For example, the content capacity system 210 obtains updates to the expected incoming content requests (e.g., a demand prediction), and available computational resources (e.g., a capacity prediction), and/or generates an updated usage matrix every 30 or 60 seconds. With updated data, the content capacity system 210 also generates an updated resource capacity policy every 30 or 60 seconds to ensure current computational costs.

Referring to FIG. 5, this figure provides additional details about determining utility scores for content-location pairs associated with a content request. In particular, FIG. 5 illustrates an example diagram of providing a content-location pair in response to a content request using a resource capacity policy according to some embodiments.

As shown, FIG. 5 includes a series of acts 500 performed by the content capacity system 210 to determine utility scores for content-location pairs. In addition, FIG. 5 includes the content-location pair values 320 and the resource capacity policy 410 introduced earlier. Specifically, the content capacity system 210 determines utility scores for content-location pairs associated with a content request based on content-location pair values 320 and the resource capacity policy 410. In various implementations, the content capacity system 210 utilizes the trained content optimization policy model to generate utility scores for the content-location pairs.

As shown, act 502 includes the content capacity system 210 determining utility scores for each content-location pair based on the resource capacity policy. In various implementations, the content capacity system 210 utilizes the content optimization policy model as a policy executor score for each content-location pair. In some instances, based on the utility score of a content-location pair, the content capacity system 210 determines whether to drop 504, reroute 506, or pass through 508 a content-location pair. Dropping refers to removing or dropping the content-location pair from the ingress data center, rerouting refers to using a different data center for distribution (e.g., egress) than the ingress data center, and passing through refers to using the same data center for both ingress and distribution.

In some implementations, act 510 scores each content-location pair and only determines whether to drop, reroute, or pass through the content-location pair with the highest utility score. In these implementations, act 510 can maximize utility and efficiency in responding to content requests. Indeed, the content capacity system 210 can maximize utility compared to computational costs (e.g., when utility>cost). Otherwise, the content capacity system 210 can drop the content request to avoid wasting computational resources at any of the data centers.

As shown, act 510 includes ignoring dropped and lower scoring pairs. Indeed, the content capacity system 210 can ignore all dropped content-location pairs and content-location pairs that do not meet a certain threshold (e.g., drop if utility score <=0). In some implementations, the content capacity system 210 ignores all but the highest scoring content-location pair (as long as the highest scoring content-location pair is above zero, otherwise the content capacity system 210 does not provide any content-location pair). By doing so, the content capacity system 210 prevents data centers from generating suboptimal content items. Additionally, the content capacity system 210 can focus a data center's resources on generating content items from the content-location pair with the highest score or in fulfilling other content requests.

As shown, act 512 includes the content capacity system 210 providing a target content type and target distribution location as indicated by the content-location pair with the highest utility score. For example, upon determining utility scores for each content-location pair, the content capacity system 210 identifies the content-location pair with the highest utility score. The content capacity system 210 further identifies the content type and distribution location from this identified content-location pair, which become the target content type and target distribution data center. In some implementations, all content-location pairs are dropped.

If the target distribution data center is the same as the incoming data center, the content capacity system 210 passes through the target content type to the same data center to generate one or more content items of the target content type and provide them in response to the content request. If the target distribution data center is different from the incoming data center, the content capacity system 210 re-routes the content request and/or provides the identified content-location pair to the target distribution data center with the target content type, for it to generate one or more content items of the target content type and provide them in response to the content request.

As mentioned above, in various implementations, the content capacity system 210 utilizes the content optimization policy model as a policy executor to score each content-location pair. For example, the content capacity system 210 performs real-time scoring of content-location pairs based on the content-location pair values 320 and the resource capacity policy 410. In some implementations, the content capacity system 210 provides additional inputs to the content optimization policy model, such as latency distributions, the maximum response limit, and computational costs (e.g., a usage matrix).

In some implementations, the content capacity system 210 uses the content optimization policy model to predict various outcomes. For example, the content optimization policy model predicts the expected utility per second for a content distribution system by solving the allocation problem as follows:

$${\sum }_{j ∈ J} v ( j , i ( j ) , e , a ) \cdot x [ λ ] ( j , e , a )$$

In some instances, this utility is based on the capacities and demands of the content distribution system. As another example, the content optimization policy model predicts the expected utilization ratio for each resource, which may be as follows:

$$\frac{{\sum }_{j ∈ J} u ( r , e , a ) x [ λ ] ( j , e , a )}{C ( r )} for all r ∈ R$$

In some cases, the content optimization policy model predicts the data center resources that are most efficient to utilize in responding to a content request (e.g., as indicated by content-location pairs with higher λ dual vector). In addition, using A, dual vector the content capacity system 210 can also provide information on which resources have excess capacity and could be removed or moved to other resources to maximize efficiency and utility (which may be revenue excluding traffic acquisition cost revenue in some instances).

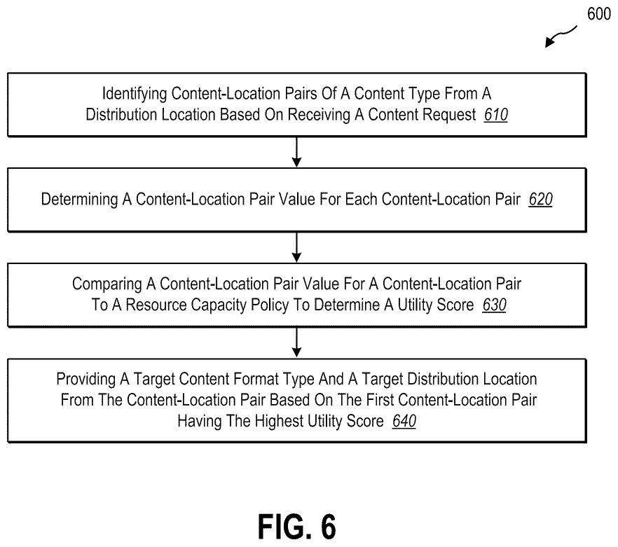

Turning now to FIG. 6, this figure illustrates an example series of acts of a computer-implemented method for determining one or more content types to provide in response to a request for content according to some implementations. While FIG. 6 illustrates acts according to one or more implementations, alternative implementations may omit, add to, reorder, and/or modify any of the acts shown.

The acts in FIG. 6 can be performed as part of a method (e.g., a computer-implemented method). Alternatively, a computer-readable medium can include instructions that, when executed by a processing system with a processor, cause a computing device to perform the acts in FIG. 6. In some implementations, a system (e.g., a processing system comprising a processor) can perform the acts in FIG. 6. For example, the system includes a processing system and a computer memory including instructions that, when executed by the processing system, cause the system to perform various actions or steps.

As shown, the series of acts 600 includes act 610 of identifying content-location pairs of a content type from and distribution location based on receiving a content request. For instance, in example implementations, act 610 involves identifying content-location pairs that each include a content format type from multiple content format types and a distribution location from multiple distribution locations based on receiving a content request at a first location. In various implementations, the content request is received at the first location to provide a content item to a client device.

As further shown, the series of acts 600 includes act 620 of determining a content-location pair value for each content-location pair. In one or more implementations, act 620 includes adjusting the content-location pair value for each content-location pair based on feasibility between the first location and the multiple distribution locations included in each content-location pair.

In various implementations, the first content-location pair value is based on an initial content-location pair value and an adjusted value and/or the adjusted value modifies the initial content-location pair value based on geographical constraints and latency constraints. In some implementations, the geographical constraints indicate available connections for providing content items between the multiple distribution locations and a content-location pair value for a content-location pair is set to at or below zero when a connection is not available between the first location and a distribution location included in the content-location pair. In some implementations, the latency constraints indicate connection times for providing content items between the multiple distribution locations, a content-location pair value for a content-location pair is set to at or below zero if latency between the first location and a distribution location included in the content-location pair is above a threshold delivery time, and the threshold delivery time corresponds to a duration within which a content item is to be provided to a client device from the content request.

As further shown, the series of acts 600 includes act 630 of comparing a content-location pair value for a content-location pair to a resource capacity policy to determine a utility score. For instance, in example implementations, act 630 involves comparing the first content-location pair value for the first content-location pair of the content-location pairs to a resource capacity policy to determine the first utility score for the first content-location pair.

In various implementations, the resource capacity policy indicates a computational cost for generating a content item of a target content format type item at a target distribution location. In some implementations, act 630 includes determining computational demand parameters for the first distribution location based on an average number of expected content requests per second expected or anticipated in the next time period and a distribution of content items of the expected content requests in the next time period based on combinations of the multiple content format types and the multiple distribution locations.

In some implementations, act 630 includes determining computational capacity parameters for the first distribution location based on a maximum number of computational calls per second in the next time period for resources at the first distribution location. In some implementations, act 630 includes generating a usage matrix that indicates resources needed to process each of the content-location pairs, wherein the usage matrix includes a table that correlates resources at each of the multiple distribution locations with the content format type and the distribution location making up each of the content-location pairs. In some implementations, the usage matrix indicates that a first resource at the first distribution location and a second resource at the first distribution location are needed to process content items of the first content format type at the first distribution location.

In some implementations, act 630 includes generating the resource capacity policy based on the computational demand parameters, the computational capacity parameters, and the usage matrix, wherein the resource capacity policy indicates current computational costs for utilizing the resources at each of the multiple distribution locations. In some implementations, the resource capacity policy is determined by solving a linear optimization problem based on the computational demand parameters, the computational capacity parameters, and the usage matrix. In some implementations, the resource capacity policy is generated in a previous time period before receiving the content request. In some implementations, the resource capacity policy is regenerated in near-real time based on destination location resource usage in current and previous time periods.

As shown further, the series of acts 600 includes act 640 of providing a target content format type and a target distribution location from the content-location pair based on the first content-location pair having the highest utility score. For instance, in example implementations, act 640 involves providing a first content format type and a first distribution location of the first content-location pair in response to the content request based on the first content-location pair having the highest utility score among utility scores associated with the content-location pairs, and using the first content format type to identify the content item to provide to the client device from the first distribution location.

In various implementations, act 640 includes determining the first utility score for the first content-location pair based on comparing the first content-location pair value for the first content-location pair to a computational cost for providing the first content-location pair. In some implementations, the computational cost for providing the first content-location pair is based on applying computational costs in the resource capacity policy for distribution location resources to resources needed to process content items of the first content format type at the first distribution location, and the computational costs are combined and compared to the first content-location pair value to generate the first utility score for the first content-location pair.

In some implementations, act 640 includes determining the utility scores for the content-location pairs based on the resource capacity policy and dropping one or more of the content-location pairs that have a utility score below zero or below a threshold value. In some implementations, act 640 includes determining the utility scores for the content-location pairs based on the resource capacity policy and determining that the first content-location pair has the highest utility score based on the first utility score being higher than other utility scores determined for the content-location pairs.

FIG. 7 illustrates certain components that may be included within a computer system 700. The computer system 700 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 700 represents one or more of the client devices, server devices, or other computing devices described above. For example, the computer system 700 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 700 includes a processing system including a processor 701. The processor 701 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 701 may be referred to as a central processing unit (CPU) and may cause computer-implemented instructions to be performed. Although the processor 701 shown is just a single processor in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 705 and the data 707 may be stored in the memory 703. The instructions 705 may be executable by the processor 701 to implement some or all of the functionality disclosed herein. Executing the instructions 705 may involve the use of the data 707 stored in the memory 703. Any of the various examples of modules and components described herein may be implemented, partially or wholly, as instructions 705 stored in memory 703 and executed by the processor 701. Any of the various examples of data described herein may be among the data 707 stored in memory 703 and used during the execution of the instructions 705 by the processor 701.

A computer system 700 may also include one or more communication interface(s) 709 for communicating with other electronic devices. The one or more communication interface(s) 709 may be based on wired communication technology, wireless communication technology, or both. Some examples of the one or more communication interface(s) 709 include a Universal Serial Bus (USB), an Ethernet adapter, a wireless adapter that operates according to an Institute of Electrical and Electronics Engineers (IEEE) 702.11 wireless communication protocol, a Bluetooth® wireless communication adapter, and an infrared (IR) communication port.

A computer system 700 may also include one or more input device(s) 711 and one or more output device(s) 713. Some examples of the one or more input device(s) 711 include a keyboard, mouse, microphone, remote control device, button, joystick, trackball, touchpad, and light pen. Some examples of the one or more output device(s) 713 include a speaker and a printer. A specific type of output device typically included in a computer system 700 is a display device 715. The display device 715 used with implementations disclosed herein may utilize any suitable image projection technology, such as liquid crystal display (LCD), light-emitting diode (LED), gas plasma, electroluminescence, or the like. A display controller 717 may also be provided for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, and a data bus. For clarity, the various buses are illustrated in FIG. 7 as a bus system 719.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transportation of electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Instead, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to exclude the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for determining one or more content types to provide in response to a request for content, comprising:
based on receiving a content request at a first location, identifying content-location pairs that each include a content format type from multiple content format types and a distribution location from multiple distribution locations;
determining a content-location pair value for each content-location pair;
comparing a first content-location pair value for a first content-location pair of the content-location pairs to a resource capacity policy to determine a first utility score for the first content-location pair; and
based on the first content-location pair having a highest utility score among utility scores associated with the content-location pairs, providing a first content format type and a first distribution location of the first content-location pair in response to the content request.

2. The computer-implemented method of claim 1, wherein:
the first content-location pair value is based on an initial content-location pair value and an adjusted value; and
the adjusted value modifies the initial content-location pair value based on geographical constraints and latency constraints.

3. The computer-implemented method of claim 2, wherein:
the geographical constraints indicate available connections for providing content items between the multiple distribution locations; and
a content-location pair value for a content-location pair is set to at or below zero when a connection is not available between the first location and a distribution location included in the content-location pair.

4. The computer-implemented method of claim 2, wherein:
the latency constraints indicate connection times for providing content items between the multiple distribution locations;
a content-location pair value for a content-location pair is set to at or below zero if latency between the first location and a distribution location included in the content-location pair is above a threshold delivery time; and
the threshold delivery time corresponds to a duration within which a content item is to be provided to a client device from the content request.

5. The computer-implemented method of claim 1, wherein the resource capacity policy indicates a computational cost for generating a content item of a target content format type item at a target distribution location.

6. The computer-implemented method of claim 1, further comprising determining computational demand parameters for the first distribution location based on:
an average number of expected content requests per second expected in a next time period; and
a distribution of content items of the expected content requests in the next time period based on combinations of the multiple content format types and the multiple distribution locations.

7. The computer-implemented method of claim 6, further comprising determining computational capacity parameters for the first distribution location based on a maximum number of computational calls per second in the next time period for resources at the first distribution location.

8. The computer-implemented method of claim 7, further comprising generating a usage matrix that indicates resources needed to process each of the content-location pairs, wherein the usage matrix includes a table that correlates resources at each of the multiple distribution locations with the content format type and the distribution location making up each of the content-location pairs.

9. The computer-implemented method of claim 8, wherein the usage matrix indicates that a first resource at the first distribution location and a second resource at the first distribution location are needed to process content items of the first content format type at the first distribution location.

10. The computer-implemented method of claim 8, further comprising generating the resource capacity policy based on the computational demand parameters, the computational capacity parameters, and the usage matrix, wherein the resource capacity policy indicates current computational costs for utilizing the resources at each of the multiple distribution locations.

11. The computer-implemented method of claim 10, wherein the resource capacity policy is determined by solving a linear optimization problem based on the computational demand parameters, the computational capacity parameters, and the usage matrix.

12. The computer-implemented method of claim 10, wherein the resource capacity policy is generated in a previous time period before receiving the content request.

13. The computer-implemented method of claim 1, wherein the resource capacity policy is regenerated in near-real time based on destination location resource usage in current and previous time periods.

14. The computer-implemented method of claim 1, further comprising determining the first utility score for the first content-location pair based on comparing the first content-location pair value for the first content-location pair to a computational cost for providing the first content-location pair.

15. The computer-implemented method of claim 14, wherein:
the computational cost for providing the first content-location pair is based on applying computational costs in the resource capacity policy for distribution location resources to resources needed to process content items of the first content format type at the first distribution location; and
the computational costs are combined and compared to the first content-location pair value to generate the first utility score for the first content-location pair.

16. The computer-implemented method of claim 15, further comprising:
determining the utility scores for the content-location pairs based on the resource capacity policy; and
dropping one or more of the content-location pairs that have a utility score below zero.

17. The computer-implemented method of claim 15, further comprising:
determining the utility scores for the content-location pairs based on the resource capacity policy; and
determining that the first content-location pair has the highest utility score based on the first utility score being higher than other utility scores determined for the content-location pairs.

18. A system comprising:
a processing system having a processor; and
a computer memory including instructions that, when executed by the processing system, cause the system to carry out operations comprising:
based on receiving a content request at a first location, identifying content-location pairs that each include a content format type from multiple content format types and a distribution location from multiple distribution locations;
determining a content-location pair value for each content-location pair;
comparing a first content-location pair value for a first content-location pair of the content-location pairs to a resource capacity policy to determine a first utility score for the first content-location pair; and
based on the first content-location pair having a highest utility score among utility scores associated with the content-location pairs, providing a first content format type and a first distribution location of the first content-location pair in response to the content request.

19. The system of claim 18, further comprising instructions that, when executed by the processing system, cause the system to carry out operations comprising:
receiving the content request at the first location to provide a content item to a client device; and
using the first content format type to identify the content item to provide to the client device from the first distribution location.

20. A computer-implemented method for determining one or more content types to provide in response to a request for content, comprising:
based on receiving a content request at a first location, identifying content-location pairs that each include a content format type from multiple content format types and a distribution location from multiple distribution locations;
determining a content-location pair value for each content-location pair;
adjusting the content-location pair value for each content-location pair based on feasibility between the first location and the multiple distribution locations included in each content-location pair;
comparing a first content-location pair value for a first content-location pair of the content-location pairs to a resource capacity policy to determine a first utility score for the first content-location pair; and
based on the first content-location pair having a highest utility score among utility scores associated with the content-location pairs, providing a first content format type and a first distribution location of the first content-location pair in response to the content request.
